(19) United States
(12) Patent Application Publication
(10) Pub. No.: US 2004/0047553 A1
(43) Pub. Date: Mar. 11, 2004

(54) Injection device for optical fibre and preparation method

(76) Inventors: Patrick Even, Lannion (FR); Benoit Metayer, Lannion (FR); Benoit Cadier, Perros Guirec (FR); David Pureur, Perros Guirec (FR)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/381,379

(22) PCT Filed: Sep. 25, 2001
(86) PCT No.: PCT/FR01/02963

(30) Foreign Application Priority Data
Sep. 26, 2000 (FR) 00/12198

(51) Int. Cl. G02B 6/26; G02B 6/28

(52) U.S. Cl. 385/31; 385/24

(57) ABSTRACT

The invention concerns an injection device for optical fibre characterised in that it comprises a main fibre (100), and an auxiliary fibre (200) whereof the beveled end (210) is placed on the edge of the main fibre (10), wherein the auxiliary fibre (200) has a numerical aperture smaller than the numerical aperture of the main fibre (100). The invention also concerns a method for preparing the device.

The present invention rel+ates to optical fibers.

More specifically, the present invention relates to an optical injection device for an optical fiber, that is to say a device designed to inject an optical signal into a fiber.

The present invention may be applied especially in the production of lasers or optical amplifiers.

The production of a high-power monomode fiber laser or a high-gain fiber amplifier requires high-power pump lasers. These are generally semiconductor diodes. In particular, multimode diodes are known. However, the characteristics of the output beam of the latter do not allow satisfactory optical coupling into a monomode fiber core. Thus, at the present time only a single monomode pump diode can be effectively coupled into the monomode core of a fiber.

Fiber lasers and fiber amplifiers are consequently power-limited, or gain-limited, respectively, by the power of the monomode pump diodes.

To inject light emanating from a pump diode into a fiber, one end of the fiber may in theory be used. Using suitable optics, such as for example a lens system, it is possible to obtain effective optical coupling [Ref. 1]. However, this means that only the other end of the fiber is then available. This type of injection therefore does not allow access to both ends of the fiber. Now, for an optical fiber amplifier, both ends are required. It is therefore not possible to use this type of injection.

Moreover, the power of pump diodes is sometimes insufficient for some laser or amplifier applications. It would therefore be desirable to combine the power of several diodes in order to obtain the required power. However, longitudinal-type injection into the end of a fiber does not allow this type of multiplexing to be easily accomplished.

Other methods of injection such as that described in [Ref. 2] have been proposed for trying to effectively couple pump diodes into fibers having large multimode sections. However, notching the fiber as proposed in that document weakens it. The risks of breakage over time are considerable. This method therefore does not meet the qualifications required for products used in the telecommunications field.

Another method of injection is that proposed by [Ref. 3]. With that method, a fiber bundle is fused together and then drawn in order to achieve the dimensions of the multimode section of an injection fiber. From the ratio of the numerical apertures of the fibers of the bundle to that of the injection fiber and the ratio of the sections of the bundle to the multimode section of the injection fiber it is possible to calculate the optimum configuration for efficient optical coupling. To optimize the coupling, the multimode section of the injection fiber is generally hexagonal or star-shaped. To have good coupling, it is necessary to maintain the geometrical extent of the N input fibers and of the injection fiber. In general, the number of fibers in the bundle is limited to seven. In order to have access to both ends of the fiber in the case of the production of an amplifier, the central fiber of the bundle must be a monomode fiber.

Reference 4 also proposes various systems for injection via the side. However, in practice, the systems proposed in that document, which use a double-clad fiber and a multimode section, having a large numerical aperture, typically 0.4, and an initiating fiber with a rectangular section and similarly a large numerical aperture, are not satisfactory.

The objective of the present invention is to provide an injection device which improves the coupling and the injection into a fiber.

This objective is achieved within the context of the present invention by means of a device comprising:

a main fiber; and

an auxiliary fiber whose beveled end is placed on the side of the main fiber, in which device the auxiliary fiber has a numerical aperture smaller than the numerical aperture of the main fiber.

The present invention also relates to a method of preparing an injection device for an optical fiber, characterized in that it comprises the steps consisting in:

beveling one end of an auxiliary optical fiber; and

placing and fastening this beveled end of the auxiliary fiber on the side of a main fiber having a numerical aperture larger than the numerical aperture of the auxiliary fiber.

Other features, objectives and advantages of the present invention will become apparent on reading the detailed description which follows, and with regard to the appended drawings given by way of nonlimiting examples, in which:

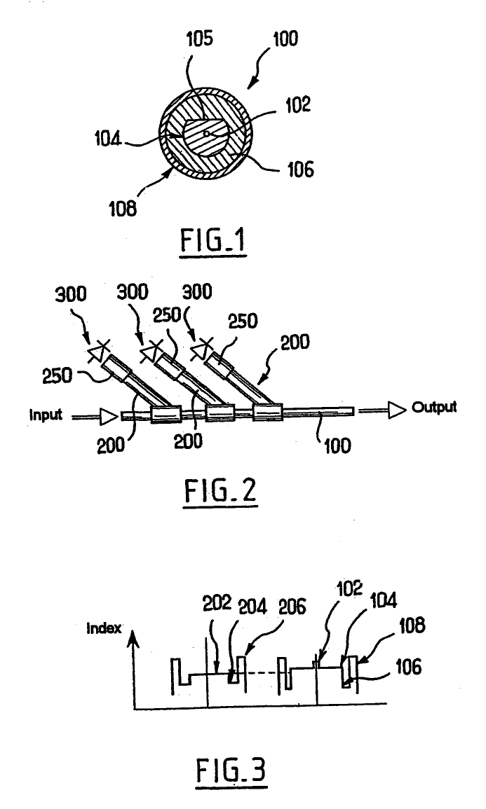

FIG. 1 shows a cross-sectional view of a double-clad fiber used preferably as the main fiber within the context of the present invention;

FIG. 2 shows schematically a multiple injection device according to the present invention;

FIG. 3 shows the optical indices of the various elements making up a multimode core fiber forming the auxiliary fiber and a monomode core fiber forming the main fiber, respectively, used within the context of the present invention;

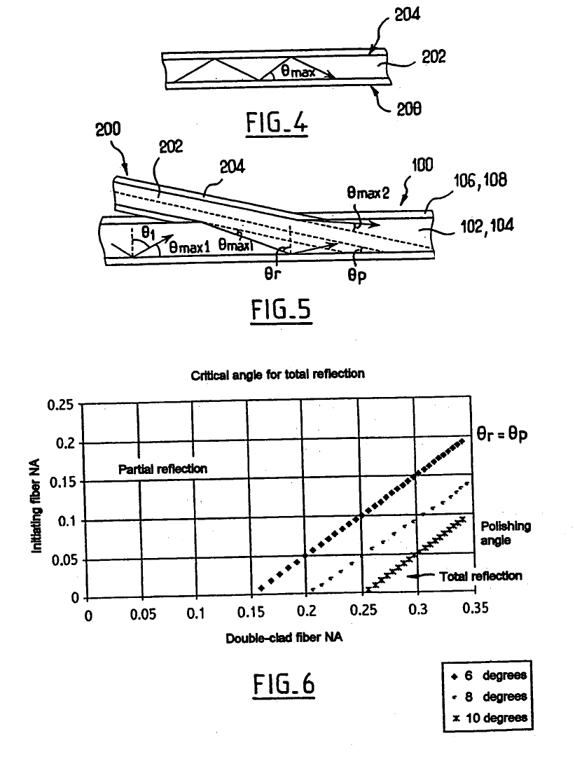

FIG. 4 shows schematically the guiding of an optical beam in a multimode fiber forming the auxiliary fiber;

FIG. 5 shows schematically the injection carried out within the context of the present invention;

FIG. 6 shows the critical angle for total reflection as a function of the numerical aperture of the fibers used;

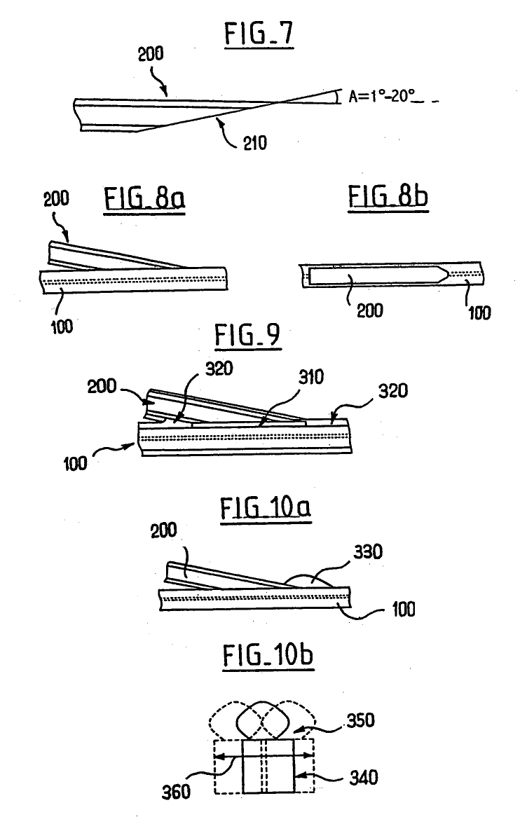

FIG. 7 shows schematically the beveled end of an initiating fiber used as the auxiliary fiber within the context of the present invention;

FIG. 8 shows an auxiliary initiating fiber placed on the side of a main fiber, according to the present invention, seen from the side in the case of FIG. 8a and seen from above in the case of FIG. 8b, respectively;

FIG. 9 shows schematically a first method of fastening an auxiliary initiating fiber to a main fiber, according to the present invention;

FIG. 10 shows schematically a second method of fastening an auxiliary initiating fiber to a main fiber, according to the present invention;

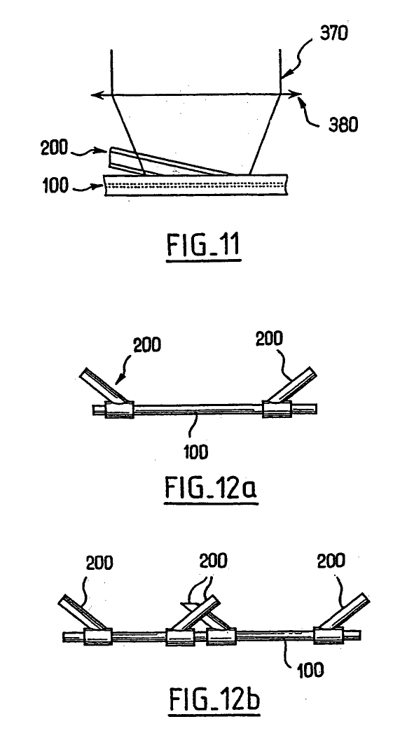

FIG. 11 shows schematically a third method of fastening an auxiliary initiating fiber to a main fiber, according to the present invention; and

FIGS. 12a and 12b illustrate two alternative methods of injection according to the present invention, with two and four diodes respectively.

As indicated above, the basic structure of the injection device according to the present invention comprises:

a main fiber; and

an auxiliary fiber 200 whose beveled end 210 is placed on the side of the main fiber 100, the auxiliary fiber 200 having a numerical aperture smaller than the numerical aperture of the main fiber 100.

Preferably, within the context of the present invention, the main fiber 100 is a double-clad fiber with a monomode core, of the type illustrated in FIG. 1.

A general description of such a fiber 100 may be found in the document [Ref. 5].

The fiber 100 illustrated in the appended FIG. 1 comprises a monomode core 102, a multimode section 104, which has at least one flat 105 and surrounds the core 102, a low-index cladding 106 and an external mechanical cladding 108. Such a double-clad fiber 100 generally has a monomode core 102 doped with one or more rare earths, which acts as an amplifying medium and as optical guide for the monomode field. The dimensions of the fiber are generally around 4 μm for the diameter of the core 102 and 21×10³ μm² for the multimode section 104. The index of the low-index cladding 106 is typically 1.35.

However, for some applications, the fiber may have different characteristics. For example, the core may have a diameter greater than 4 μm.

The multimode section 104 advantageously has an index less than that of the core 102. The low-index cladding 106 advantageously has an index less than that of the multimode section 104, while the external mechanical cladding 108 has a higher index, greater than that of the core 102.

As a variant, the main fiber 100 used in the context of the present invention may be a more conventional multimode fiber.

The auxiliary fiber 200 is advantageously a fiber having a multimode core 202, surrounded by a lower-index optical cladding 204 and an outer mechanical cladding 206, having an index greater than that of the core 202.

As illustrated in FIG. 2, several auxiliary fibers may be associated with a main fiber 100.

The transverse injection proposed within the context of the present invention thus allows efficient optical coupling of one or more pump diodes 300 each placed opposite the free end of a respective auxiliary fiber 200, in the multimode section 104 of a fiber 100. The ends of this fiber 100 are therefore available.

The diodes 300 are advantageously high-power multimode pump diodes.

To obtain optimum coupling, it is preferable to have a diode pigtail, that is to say, between each diode 300 and the input of the associated auxiliary fiber 200, a length of fiber 250 which is matched to the diode and the core size and numerical aperture of which are similar to those of the initiating multimode fiber 200. Typically, the pigtail 250 is a 100/125 fiber of 0.15 numerical aperture. The pigtail 250 is bonded to the initiating fiber 200 using a standard process.

If the diode 300 is not pigtailed, it is possible to couple the light directly into the initiating fiber 200 by means of a lens system.

The multimode auxiliary initiating fiber 200 has a core 202 of index less than or equal to the index of the multimode section 104 of the main fiber 100 (as may be seen in FIG. 3). The greater the index difference, the less the propagation of the electromagnetic field 4 in the multimode section 104 is disturbed upon crossing the point of junction. In the case of an index difference greater than or equal to the index difference between the multimode section 104 and the low-index cladding 106, the propagation of the field is not affected upon crossing the point of junction.

The numerical aperture of the initiating fiber 200 must be sufficiently small—typically this numerical aperture NA is 0.15—while remaining compatible with a good optical coupling coefficient with the pump diode 300.

The main fiber 100 must have the largest possible numerical aperture, typically NA=0.4. The index difference between the multimode section 104 and the low-index cladding 106 must be as large as possible. Preferably, to obtain such numerical apertures, the low-index cladding 106 is a silicone.

The present invention is based in particular on the following considerations.

An analysis of the critical angles of the interface between two media of different indices stresses the importance of the numerical apertures of the main fiber 100 and the auxiliary fiber 200.

If n_{co} and n_{c1} are the index of the core and of the optical cladding, respectively, of a multimode fiber as shown schematically in FIG. 4, the maximum angle of reflection at the core/cladding interface is given by:

θₘₐₓ=a sin (NA/n_{co}) (1) with

NA=\sqrt{n²_{co}−n²_{c1}} (2)

where NA represents the numerical aperture of the fiber.

Let us consider the case in which the multimode section 104 of the fiber 100 and the core 202 of the initiating fiber 200 have the same optical index. For total reflection, the following equation is obtained between the numerical apertures:

θ₁+θₘₐₓ₁=π/2 (3) with

θ₁=a sin (n_{c1 2}/n_{co2}) (4) and

θᵣ=π/2−θₘₐₓ₂−θₚ (5)

in which:

θₘₐₓ₁ is the maximum angle for total reflection in the double-clad fiber 100 (multimode propagation);

θₘₐₓ₂ is the maximum angle for total reflection in the auxiliary initiating fiber 200;

θᵣ is the angle of reflection of the most inclined beam emanating from the auxiliary initiating fiber 200 at the core/cladding interface of the fiber 100;

θₚ is the polishing angle of the initiating fiber 200; and

θ₁ is the critical angle at the core/cladding interface of the fiber 100.

To have total reflection of the most inclined beam emanating from the auxiliary initiating fiber 200 at the core/cladding interface of the main fiber 100, the following condition must be respected:

θᵣ≧θ₁ (6) i.e.

π/2−θₘₐₓ₁−θₚ≧θ₁ (7),

which may be written as:

(π/2)−a sin (NA₁/n_{co1})θθₚ≧a sin (n_{cl2}/n_{co2})=a sin (1−(NA²₂/n²_{co2}))^{1/2} (8) i.e.

a sin (NA₁/n_{co1})≧(π/2)−θₚ−a sin (1−(NA²₂/n²_{co2}))^{1/2} (9)

FIG. 6 illustrates the critical angle of total reflection as a function of the indices of the fibers 100 and 200. FIG. 6 shows three curves corresponding to bevel angles of 6°, 8° and 10° respectively, for the end of the auxiliary fiber 200. To the left of these curves, there is partial reflection. In contrast, to the right of these curves, there is total reflection.

It is thus apparent from equation (9) and FIG. 6 that it is necessary to minimize the numerical aperture of the initiating fiber 200 and maximum the numerical aperture of the main fiber 100. The polishing angle must also be as small as possible.

Optical coupling takes place by positioning the auxiliary initiating fiber 200 on the side of the main fiber 100.

In the assembled state, the two fibers 100 and 200 have their longitudinal axes coplanar.

The auxiliary initiating fiber 200 is polished beforehand at its end 210 with an angle of about 1° to 20° (FIG. 7). The polishing is carried out by a standard process. The tolerance on the polishing angle depends on the tolerance on the numerical apertures of the initiating fiber 200 and the main fiber 100. The greater the difference in numerical aperture, the greater this angle may be.

For an initiating fiber 200 of 0.15 numerical aperture, and a main fiber 100 of 0.34 numerical aperture, the polishing angle is typically 6°.

The positioning of the initiating fiber 200 on the side of the main multimode fiber 100 must be carried out in a precise manner, as shown schematically in FIG. 8. To ensure this positioning, a few millimeters of the low-index cladding 106 of the main fiber 100 must first be removed.

The auxiliary initiating fiber 200 must then be fastened to the side of the multimode section of the main fiber 100.

Various manufacturing processes may be used for this purpose.

To have satisfactory coupling, the initiating fiber 200 may be cemented to the side of the main fiber 100 or fusion-bonded with the latter.

FIG. 9 illustrates a first implementation in which the auxiliary initiating fiber 200 is fastened by cementing to the main fiber 100.

The cement 310 used must have an index lying between that of the core 202 of the initiating fiber 200 and that of the multimode section 104 of the main fiber 100. A UV-curable epoxy cement compound is suitable for this application. A microdrop is sufficient for the cementing. It is necessary to prevent the cement 310 from extending beyond the interface between the initiating fiber 200 and the main fiber 100.

Any other component meeting these criteria may be used. The limitation is the resistance to the intense flux from the pump laser and the aging over time. The index of the cement 310 and its transparency must not change. The cement 310 must be able to meet the qualifications imposed by the application in question.

Once the cement 310 has cured, the main fiber 100 must be reclad with the low-index cladding 106 as illustrated in FIG. 9 under the reference 320.

As mentioned above, the auxiliary initiating fiber 200 may also be fastened to the main fiber 100 by fusion bonding.

This fusion bonding may, for example, be carried out by a microtorch.

The fusion bonding is then preferably carried out by means of the flame of a microtorch of the oxidant/butane type. Other gas mixtures may also be envisioned. The size of the flame is such that the area heated covers the area of contact between the two fibers 100 and 200. To prevent the initiating fiber 200 deforming during the fusion bonding, it is possible to use a glass with a low Tg, such as B₂O₃, to pre-cement the end of the initiating fiber to the injection fiber (as shown schematically in FIG. 10a). The temperature of the flame, its position and its composition are critical parameters of the fusion bonding process. To make the heated area uniform, it is possible to make the flame undergo an oscillating longitudinal movement as shown schematically in FIG. 10b.

In FIG. 10a, the element made of B₂O₃ glass has the reference 330. In FIG. 10b, the torch has the reference 340, its flame 350 and the oscillating movement of the torch 340 is shown schematically by the arrow with the reference 360.

After fusion bonding, the main fiber 100 must be reclad with the low-index cladding 106.

Another solution consists in fastening the auxiliary fiber 200 by fusion bonding it with a laser, for example using a CO₂ laser.

An alternative to fusion bonding using a flame is in fact the use of a CO₂ power laser. The emission line at 10.6 μm of the CO₂ laser is strongly absorbed by the glass. Such a laser therefore makes it possible to control the area of heating more precisely and is more flexible to use than a flame. The beam 370 is focused by means of a lens 380 designed to have a focal spot of the same size as the interface of the two fibers 100, 200 to be cemented (as illustrated in FIG. 11). The temperature gradient between the top of the fiber 100 and the lower face is very large. The advantage is that it is possible to reach a temperature slightly above the T_{g} on the upper face without reaching this temperature at the center of the fiber 100 or at the lower face. The risk of deforming the fiber is therefore lessened.

After fusion bonding, the fiber 100 must be reclad with the low-index cladding 106. The use of B₂O₃ glass is also possible for the reasons described above.

According to yet another preferred embodiment of the present invention, the fastening of the fiber 200 is carried out by combining a flame with a CO₂ laser.

Cementing using a flame is in fact a difficult manufacturing process to control. The temperature at the interface between the two fibers 100/200 must be stable and well controlled, slightly higher than the T_{g} of the core 202 of the initiating fiber 200. Too high a temperature deforms the fibers and, conversely, too low a temperature does not allow cementing.

The CO₂ laser gives a very localized heating area. The high temperature gradient does not allow homogenization of the stresses in the fiber.

Combining the two processes (flame and CO₂ laser) allows these difficulties to be overcome. The flame heats the fibers 100 and 200 locally to a temperature below the T_{g}. The flame produces a much smaller temperature gradient in the fiber than CO₂. The amount of heat needed to reach a temperature above the T_{g} is produced by the CO₂ laser beam. In this case, the flame-regulating parameters are less critical. The temperature at the interface is controlled by adjusting the power of the CO₂ laser.

After fusion bonding, the fiber 100 must again be reclad with the low-index cladding 106. The use of B₂O₃ glass is also possible for the reasons described above.

Trials carried out by the Applicant have led to the following coupling coefficients.

The coupling coefficient is defined by the ratio of the power injected into the initiating fiber 200 to the power output by the main fiber 100.

| | Epoxy cement | Flame and/or CO₂ |
|---|---|---|
| Type of cementing | compound | fusion bonding |
| Typical coupling | 65%-75% | 75%-85% |
| coefficient | | |

As was indicated above, it is possible to combine several injections in order to multiplex the power of the pump diodes.

The distance between the various injection systems is not critical and may vary from a few centimeters to a few meters. The position along the main fiber 100 of the various injections and their orientations depend on the application. FIGS. 12a and 12b show a configuration example for two and four pump diodes, respectively.

According to FIG. 12a, the injections are carried out in opposite directions.

FIG. 12b shows a variant comprising two injections in a first direction and two injections in the opposite direction.

It is possible to use other configurations.

A person skilled in the art will understand that the present invention makes it possible in particular to obtain high-power monomode lasers or high-gain amplifiers.

Of course, the present invention is not limited to the particular embodiments that have just been described, rather it extends to all variants in accordance with the spirit of the invention.

### REFERENCES

1) “Design of a device for pumping a double-clad fiber with a laser diode bar”, L. A. Zenteno, Applied Optics, Vol. 33, No. 31, 1994.

2) “High efficiency side-coupling of light into optical fibers using imbedded V-grooves”, D. J. Ripin and L. Goldberg, Elect. Letters, Vol. 31, No. 25, 1995.

3) U.S. Pat. No. 5,864,644.

4) U.S. Pat. No. 4,815,079.

5) U.S. Pat. No. 5,534,558.

1. An injection device for an optical fiber, characterized in that it comprises:
a main fiber (100); and
an auxiliary fiber (200) whose beveled end (210) is placed on the side of the main fiber (100), in which device the auxiliary fiber (200) has a numerical aperture smaller than the numerical aperture of the main fiber (100).

2. The device as claimed in claim 1, characterized in that the auxiliary fiber (200) is a multimode fiber which has a core (202) of index less than or equal to the index of a multimode section (104) of the main fiber (100).

3. The device as claimed in either of claims 1 and 2, characterized in that the index difference between the core (202) of the auxiliary fiber (200) and a multimode section (104) of the main fiber (100) is greater than or equal to the index difference between the multimode section (104) and a low-index cladding (106) of the main fiber (100).

4. The device as claimed in one of claims 1 to 3, characterized in that the numerical aperture of the initiating fiber (200) is around 0.15.

5. The device as claimed in one of claims 1 to 4, characterized in that the main fiber (100) has a numerical aperture of around 0.4.

6. The device as claimed in one of claims 1 to 5, characterized in that the main fiber (100) is a double-clad fiber with a monomode core.

7. The device as claimed in one of claims 1 to 6, characterized in that the main fiber (100) comprises a monomode core (102), a multimode section (104), which has at least one flat (105) and surrounds the core (102), a low-index cladding (106) and an external mechanical cladding (108).

8. The device as claimed in claim 7, characterized in that the low-index cladding (106) is a silicone.

9. The device as claimed in either of claims 7 and 8, characterized in that the auxiliary fiber (200) is placed on the side of the multimode section (104) of the main fiber (100).

10. The device as claimed in one of claims 7 to 9, characterized in that the multimode section (104) of the main fiber (100) has an index less than that of the core (102), the low-index cladding (106) has an index less than that of the multimode section (104), while the external mechanical cladding (108) has an index greater than that of the core (102).

11. The device as claimed in one of. claims 1 to 7, characterized in that the main fiber (100) is a multimode fiber.

12. The device as claimed in one of claims 1 to 11, characterized in that the auxiliary fiber (200) is a fiber having a multimode core (202) surrounded by an optical cladding (204) of lower index.

13. The device as claimed in claim 12, characterized in that the auxiliary fiber (200) also has an external mechanical cladding (206) of index greater than that of the core (202).

14. The device as claimed in one of claims 1 to 13, characterized in that several auxiliary fibers (200) are associated with one main fiber (100).

15. The device as claimed in one of claims 1 to 14, characterized in that it comprises at least one pump diode (300) opposite the end of an auxiliary fiber (200).

16. The device as claimed in claim 15, characterized in that the diode (300) is a high-power multimode pump diode.

17. The device as claimed in either of claims 15 and 16, characterized in that it comprises a diode pigtail, that is to say, between each diode (300) and the input of the associated auxiliary fiber (200), a length of fiber which is matched to the diode and the core size and the numerical aperture of which are similar to those of the auxiliary fiber (200).

18. The device as claimed in one of claims 1 to 17, characterized in that the pigtail is a 100/125 fiber of 0.15 numerical aperture.

19. The device as claimed in either of claims 15 and 16, characterized in that the diode (300) is coupled directly into the auxiliary fiber (200) by means of a lens system.

20. The device as claimed in one of claims 1 to 19, characterized in that the auxiliary fiber (200) is polished at its end at an angle of about 1° to 20°.

21. The device as claimed in one of claims 1 to 20, characterized in that the initiating fiber (200) has a numerical aperture of around 0.15, the main fiber (100) has a numerical aperture of around 0.34 and the polishing angle is around 6°.

22. The device as claimed in one of claims 1 to 21, characterized in that the auxiliary initiating fiber (200) is fastened to the side of the main fiber (100).

23. A method of preparing an injection device for an optical fiber, characterized in that it comprises the steps consisting in:
beveling one end of an auxiliary optical fiber (200); and
placing and fastening this beveled end of the auxiliary fiber (200) on the side of a main fiber (100) having a numerical aperture larger than the numerical aperture of the auxiliary fiber (200).

24. The method as claimed in claim 23, characterized in that the initiating fiber (200) is cemented to the side of the main fiber (100).

25. The method as claimed in claim 24, characterized in that the cement has an index lying between that of the core (202) of the auxiliary fiber (200) and that of a multimode section (104) of the main fiber (100).

26. The method as claimed in one of claims 23 to 25, characterized in that the cement is a UV-crosslinkable epoxy cement.

27. The method as claimed in claim 23, characterized in that the auxiliary initiating fiber (200) is fastened to the main fiber (100) by fusion bonding.

28. The method as claimed in claim 27, characterized in that the auxiliary fiber (200) is prebonded to the main fiber (100) by means of a glass with a low T_{g}, such as B₂O₃.

29. The method as claimed in claim 27 or 28, characterized in that the fusion bonding is performed by a microtorch.

30. The method as claimed in one of claims 27 to 29, characterized in that the auxiliary fiber (200) is fastened by laser fusion bonding, for example by means of a CO₂ laser.

31. The method as claimed in one of claims 27 to 30, characterized in that the fiber (200) is fastened by the combination of a flame and a CO₂ laser.

32. The method as claimed in one of claims 23 to 31, characterized in that the main fiber (100) is reclad with a low-index cladding (106) after the auxiliary fiber (200) has been fastened.

33. The application of the device as claimed in one of claims 1 to 22 for producing a laser.

34. The application of the device as claimed in one of claims 1 to 22 for the production of an optical amplifier.
